(19) United States
(12) Patent Application Publication
(10) Pub. No.: US 2009/0310879 A1
(43) Pub. Date: Dec. 17, 2009

(54) METHODS, SYSTEMS AND COMPUTER READABLE MEDIUMS FOR USE IN IMPROVING AN IMAGE

(76) Inventor: Carl Jung IM, Hong Kong (CN)

Correspondence Address: BUCKLEY, MASCHOFF & TALWALKAR LLC, 50 LOCUST AVENUE, NEW CANAAN, CT, 06840, US

(21) Appl. No.: 12/137,793

(22) Filed: Jun. 12, 2008

(51) Int. Cl. G06K 9/40

(52) U.S. Cl. 382/254

(57) ABSTRACT

Aspects, methods, systems and/or computer readable mediums are provided for use in improving an image. In one aspect, a method includes: selecting an original image for improvement; generating automatically a plurality of variations of said original image; displaying said original image and said plurality of variations on a display device; and selecting a currently preferred image from said displayed images. In another aspect, a method includes: selecting an original image; generating a plurality of variations of said original image; displaying said original image and said plurality of variations on a display device; selecting a currently preferred image from said displayed images; generating a plurality of variations of said currently preferred image; displaying said currently preferred image and said plurality of variations of said currently preferred image on a display device; and selecting a new currently preferred image from said displayed images.

### FIELD

The present disclosure relates to methods, systems and computer readable mediums for use in improving an image.

### BACKGROUND

More and more people have an ability to take digital photographs. High quality digital cameras are inexpensive. Many mobile telephones are capable of taking high quality digital photographs. As more and more people take digital photographs, there is an increasing need for an ability to easily edit digital photographs and images.

Many programs are available to edit images, providing users with a seemingly endless number of options. These programs often come with huge, lengthy and technical manuals. For example, the user manual that accompanies Adobe® Photoshop® (a popular image editing application) is hundreds of pages long, and highly technical in nature. A typical image editing program or tool has dozens of technical options and features.

This approach, used by most existing programs for editing images, has a number of drawbacks that prevent broad-base acceptance and demand. For example, it takes a huge time commitment for a new user to study the range of available options before the user can start editing images with the program. Further, users are required to have a certain amount of familiarity with menu-driven programs and image processing. Once studied, most manuals must be studied or referenced again and again if the user is an infrequent user of the program. The problem is made worse if an upgraded version of the image editing software is released. Frequently, upgrades to these complex software programs require additional study to relearn how to effectively use the software.

One approach used by many image editing programs to address these drawbacks is to provide “simple” functions, often just one, that make certain types of edits automatically. Such functions can greatly reduce the level of effort needed on the part of the user. However, the results are often of lower quality than can be achieved using a set of manual options. Moreover, a novice user must still learn how to invoke such an automatic editing program within the overall software program interface.

### BRIEF DESCRIPTION OF THE DRAWINGS

FIG. 1 is a flow chart of a method, in accordance with some embodiments.

FIG. 2 is a schematic diagram of a plurality of images, in accordance with some embodiments.

FIG. 3 is a flow chart of a method, in accordance with some embodiments.

FIG. 4 is a flow chart of a method, in accordance with some embodiments.

FIGS. 5A and 5B are schematic diagrams of systems, in accordance with some embodiments.

FIGS. 6A and 6B are schematic diagrams of a window that provides a view in a graphical user interface, in accordance with some embodiments.

### DETAILED DESCRIPTION

Applicant has discovered a method and system for editing images which eliminates or substantially reduces a number of drawbacks of prior image editing systems. Pursuant to some embodiments, users are able to easily edit and enhance images without reference to complex manuals or systems. Embodiments allow even novice users to enhance or edit images. Features of some embodiments will be described below and variations will be apparent to those skilled in the art upon reading this disclosure.

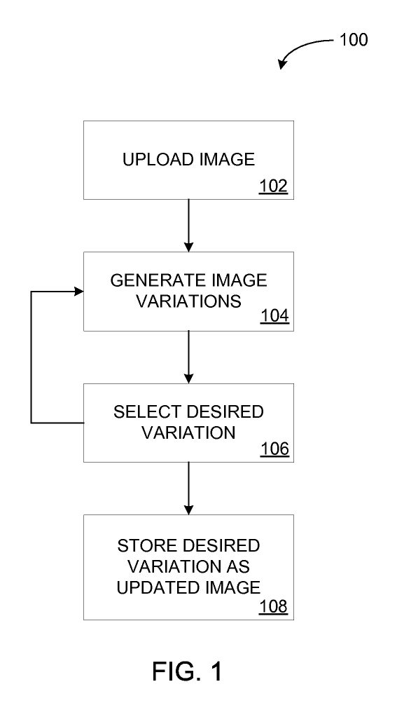

FIG. 1 is a flow chart of a method 100 according to some embodiments. In some embodiments, one or more portions of the method are used in improving an image. Referring to FIG. 1, at 102, the method may include uploading an image. In some embodiments, the uploaded image defines an original image, a currently preferred image and/or an image for improvement. As used herein, the term “image” is used to refer to static images (e.g., such as those generated by a digital still camera), as well as dynamic images or videos. For example, in some embodiments, an image to be manipulated may be uploaded or retrieved from a still or a video digital camera and uploaded for further manipulation as described further below. As another example, the image to be manipulated may be uploaded or retrieved from a data feed or data source such as YouTube® (for video images, for example), or Flickr® (for still images, for example).

In some embodiments, uploading is performed using at least one of a computer, a kiosk, a copier, a scanner, a digital camera, a digital photo-frame, a hand-held device with a display window, or any similar device suitable for uploading or selecting images or for processing digital data, displaying images or for communicating with such devices. In some embodiments, the computer, kiosk, copier, scanner, digital camera, stand-alone digital photo-frame, hand-held device with a display window, or any similar device is networked. In some embodiments, uploading is performed by a user operating at least one of a networked computer and a networked kiosk.

In some embodiments, a user uploads an image file to a processing server and selects an image in the image file as the uploaded image. In some embodiments, uploading and/or selecting is performed using at least one of a computer, a kiosk. In some embodiments, the computer and/or the kiosk is networked. In some embodiments, uploading and/or selecting is performed by a user operating at least one of a networked computer and a networked kiosk.

In some embodiments, the computer and/or kiosk may comprise a computer and/or kiosk in a retail outlet. In some embodiments, the retail outlet may comprise one of a plurality of retail outlets operated under a brand name, sometimes referred to herein as a retail outlet chain. Examples of retail outlet chains include but are not limited to WALMART®, WALGREENS® and CVS®. Processing at 102 may further include displaying the original image on a specially designated display area so that the user can keep track of his or her progress by comparing the currently preferred image to the original image.

In some embodiments, a user uploads an image file to a stand-alone digital photo-frame.

At 104, the method may further include automatic generation of image variations. In some embodiments, the image variations comprise variations of the uploaded image.

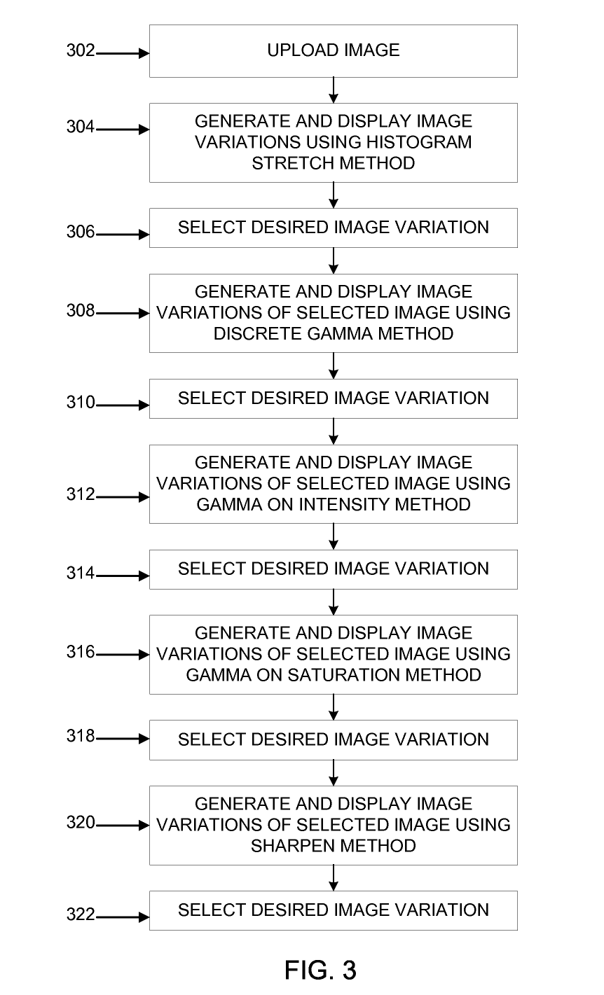

In some embodiments, each automatic generation of image variation results from modifying one or more characteristics of the image. Thus, a first image variation may have one or more characteristics of the image modified to a first setting, a second image variation may have a second setting for such one or more characteristics of the image, a third image variation may have a third setting for such one or more characteristics of the image, and so on. A number of illustrative, but not limiting, functions that may be used to manipulate images using embodiments of the present invention are described below in conjunction with FIG. 3. Those skilled in the art will appreciate that other or additional image processing functions may be used with equally desirable results.

In some embodiments, a function is used in generating each image variation. In some such embodiments, the function may be used a first time to generate the first image variation, a second time to generate the second image variation, a third time to generate a third image variation, and so on.

In some embodiments, a function is specified by a function name and one or more parameters. One or more of the parameters may represent a setting that is desired for the one or more characteristics being varied in the image variations. Thus, a parameter may have a first value (representing a first setting) if the function is being used to generate the first image variation, a second value (representing a second setting) if the function is being used to generate the second image variation, a third value (representing a third setting) if the function is being used to generate the third image variation, and so on.

In some embodiments, parameter values representing desired settings are predetermined, dynamically determined and/or a combination thereof.

In some embodiments, the parameter values and/or desired settings are provided by any source or sources of data and/or criteria.

In some embodiments, generating image variations includes automatically manipulating image contrast data (and/or other data) associated with the uploaded image, wherein each of said plurality of variations has a different image contrast setting (and/or other image characteristic setting) based on the uploaded image.

In some embodiments, generating image variations includes automatically manipulating at least one of (i) brightness data associated with the uploaded image, (ii) image intensity data associated with the uploaded image, (iii) hue data associated with the uploaded image, (iv) saturation data associated with the uploaded image, and (iv) image sharpening data associated with the uploaded image.

In some embodiments, the method includes automatic generation of image variations by randomly choosing suspected red-eyes and assuming these are the correct ones, performs red-eye removal process on the said suspected red-eyes. Then the user can choose from the automatically generated image variations, the image with actual red-eyes processed.

In some embodiments, the method includes displaying the uploaded image and the image variations on a display device. In some embodiments, the uploaded image and the image variations are all displayed on the display device at the same time. In some embodiments, the uploaded image and the image variations are displayed in a three by three matrix. In some embodiments, the plurality of images may be displayed in smaller (e.g., such as a one by two matrix, etc.) or in a larger (e.g., such as a three by four matrix, etc.) matrix. Whether a smaller or a larger matrix is to be used can be selected or configured by the user. Further, the size of the matrix may be automatically determined based on the screen size, the display resolution, and/or other capabilities of the device being used. For example, images manipulated on a hand-held device may be displayed on a smaller matrix, while images manipulated on a kiosk or computer display may be displayed on a larger matrix.

At 106, the method may further include selecting a desired variation (i.e., a desired one of the image variations). In some embodiments, the desired variation defines a currently preferred image.

In some embodiments, all of the image variations are generated and displayed before a selection is made.

In some embodiments, it may be possible to select the uploaded image, rather than an image variation, as the currently preferred image. In such embodiments, the method may include selecting a currently preferred image from a group of images that includes the uploaded image and the image variations.

At 108, the method may further include storing the desired variation as an updated image.

In some embodiments, 104-106 may be repeated, with the uploaded image at 104-106 being replaced by the currently preferred image, until a final image is selected. While repeating 104-106, an “undo” function may be available so that the user may revert to the previous image (or previous images). Thus, the method may include generating image variations, where the image variations comprise variations of a currently preferred image and selecting a desired variation from the image variations. In some embodiments, the method includes saving the final image (and/or any image generated by the method) in a computer-readable image format.

In some embodiments, it may be possible to select the currently preferred image, rather than an image variation, as the currently preferred image. Thus, the method may include selecting a currently preferred image from a group of images that includes the currently preferred image and the image variations.

The method 100 is not limited to the order shown in the flow chart. Rather, embodiments of the method 100 may be performed in any order that is practicable. For that matter, unless stated otherwise, any method disclosed herein may be performed in any order that is practicable. Notably, some embodiments may employ one or more portions of the method without one or more other portions of the method. In addition, unless stated otherwise, the method 100 may be performed in any manner. In that regard, in some embodiments, one or more portions of one or more methods disclosed herein may be performed by and/or using a processing system.

As used herein, a processing system may be any type of processing system. For example, a processing system may be programmable or non programmable, digital or analog, general purpose or special purpose, dedicated or non dedicated, distributed or non distributed, shared or not shared, and/or any combination thereof. A processing system may comprise one or more processors. A processor may comprise any type of processor. For example, a processor may be programmable or non programmable, general purpose or special purpose, dedicated or non dedicated, distributed or non distributed, shared or not shared, and/or any combination thereof. A processor may include, but is not limited to, hardware, software, firmware, and/or any combination thereof. Hardware may include, but is not limited to off the shelf integrated circuits, custom integrated circuits and/or any combination thereof. Software may include, but is not limited to, instructions that are storable and/or stored on a computer readable medium, such as, for example, punch cards, paper tape, magnetic or optical disk, magnetic or optical tape, CD-ROM, DVD, RAM, EPROM, or ROM. A processor may employ continuous signals, periodically sampled signals, and/or any combination thereof.

If a processing system is distributed, two or more portions of the processing system may communicate with one another through a communication link.

In some embodiments, a processing system comprises a user device, a computer, a copier, a scanner, a digital camera, a kiosk, a stand-alone digital photo-frame, a hand-held device with a display window and/or any similar device suitable for displaying images. In some embodiments, the user device, computer, kiosk, copier, scanner, digital camera, stand-alone digital photo-frame, hand-held device with a display window and/or any similar device is networked.

In some embodiments, one or more portions of one or more methods disclosed herein may be performed by a user operating one or more portions of a processing system.

As used herein, a communication link may comprise any type of communication link, for example, but not limited to wired (e.g., conductors, fiber optic cables) or wireless (e.g., acoustic links, electromagnetic links or any combination thereof including, for example, but not limited to microwave links, satellite links, infrared links), and/or any combinations thereof. A communication link may be public or private, dedicated and/or shared (e.g., a network) and/or any combination thereof. A communication link may or may not be a permanent communication link. A communication link may support any type of information in any form, for example, but not limited to, analog and/or digital (e.g., a sequence of binary values, i.e. a bit string) signal(s) in serial and/or in parallel form. The information may or may not be divided into blocks. If divided into blocks, the amount of information in a block may be predetermined or determined dynamically, and/or may be fixed (e.g., uniform) or variable. A communication link may employ a protocol or combination of protocols including, for example, but not limited to the Internet Protocol.

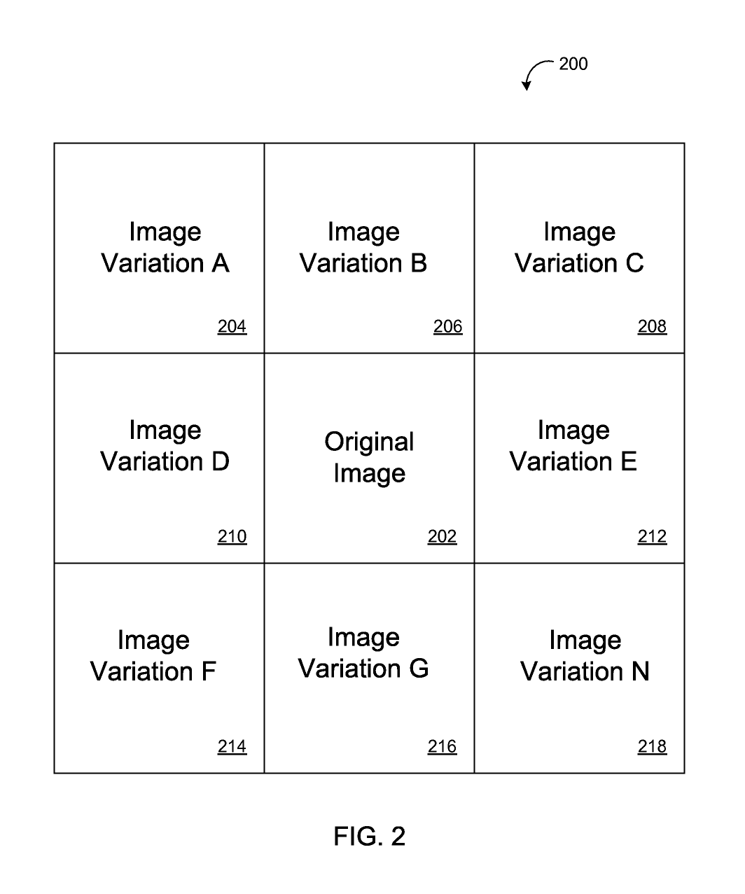

FIG. 2 is a schematic diagram 200 of a plurality of images, in accordance with some embodiments. Referring to FIG. 2, the plurality of images include nine images 202-218 displayed in a three by three (3×3) matrix. An image 202 is displayed at a center of the matrix. Images 204-218 are displayed in outer columns and/or outer rows of the matrix. Those skilled in the art, upon reading this disclosure, will appreciate that other matrix sizes may be used. Further, matrixes (or linear sets of images) may be sized or laid out depending on the screen resolution or display characteristics of a user device (e.g., a handheld user device may have images presented in a 2×2 matrix or in a single row of 2 or 3 images), or based on user-input preferences.

In some embodiments, image 202 comprises an original image, a currently preferred image and/or an image for improvement. In some embodiments, images 204-218 comprise variations of the image 202. More particularly, image 204 comprises a first image variation A of the image 202. Image 206 comprises a second image variation B of the image 202. Image 208 comprises a third image variation C of the image 202. Image 210 comprises a fourth image variation D of the image 212. Image 212 comprises a fifth image variation E of the image 202. Image 214 comprises a sixth image variation F of the image 202. Image 216 comprises a seventh image variation G of the image 202. Image 212 comprises an nth image variation N of the image 202.

In some embodiments, a user may select an image from (i) the images 204-218 and/or (ii) the images 202-218. In some embodiments, such selected image defines a new currently preferred image.

In some embodiments, all of the image variations are generated and displayed before a selection is made.

FIG. 3 is a flow chart of a method 300 according to some embodiments. In some embodiments, one or more portions of the method are used in improving an image. Referring to FIG. 3, at 302, the method may include uploading an image. In some embodiments, the uploaded image defines an original image, a currently preferred image and/or an image for improvement.

In some embodiments, uploading is performed using at least one of a computer, a kiosk, a copier, a scanner, a digital camera, a digital photo-frame, a hand-held device with a display window, or any similar device suitable for displaying images. In some embodiments, the computer, kiosk, copier, scanner, digital camera, digital photo-frame, hand-held device with a display window, or any similar device is networked.

In some embodiments, uploading is performed by a user operating at least one of a computer, a kiosk, a stand-alone digital photo-frame, a hand-held device with a display window, or any similar device suitable for displaying images. In some embodiments, the computer, kiosk, stand-alone digital photo-frame, hand-held device with a display window, or any similar device is networked.

In some embodiments, a user uploads an image file to a processing server and selects an image in the image file as the uploaded image. In some embodiments, uploading and/or selecting is performed using at least one of a networked computer and a networked kiosk. In some embodiments, uploading and/or selecting is performed by a user operating at least one of a networked computer and a networked kiosk.

At 304, the method may further include generating image variations using a histogram stretch method. In some embodiments, the image variations comprise variations of the uploaded image.

In some embodiments, generating image variations using a histogram stretch method includes automatically manipulating colors associated with the uploaded image, wherein each of said plurality of variations has different variation of the color associated with the uploaded preferred image.

In some embodiments, generating image variations using a histogram stretch method includes generating the image variations from the uploaded image using varying degrees of a function referred to herein as a “histogram stretch” function that (i) separates the original image into copies of the original image, one each in red, blue, and green, (ii) applies stretching to the red, blue and green monochromatic images and (iii) combines the stretched images to produce a full color image.

Stretching is explained below with respect to the red monochromatic image.

Stretching the red monochromatic image “stretches out” the range of the color red that is in the monochromatic image to the full range of the color red that can be displayed on the screen. This may be performed as follows. Assume, for example, that a pixel in a digital monochromatic image is represented as a number between 0 to 255, where 0 represents the darkest red color the display can show, and 255 represents the brightest red color that can be displayed on the device. For a red monochromatic image associated with an original picture with underexposure, the range of colors are not from 0 to 255 but rather are squeezed to the lower-end of this range, for example, 0 to 100.

In some embodiments, the “histogram stretch” function uses a linear transformation to transform the narrow range, e.g., 0 to 100, of the color red to a wider range, e.g., from 0 to 255. One way to do this is to multiply each number that represents red-intensity by 2.55. If the narrow range is from 100 to 200, instead of from 0 to 100, in some embodiments, each number may be decreased by 100 and then multiplied by 2.55 to obtain the range of 0 to 255.

In some embodiments, the method creates a histogram of the distribution of the red colors, replaces the darkest 1% of the red to 0, replaces the brightest 1% of the picture to 255, and replaces all the shades of red that is brighter than the darkest 1% but darker than the brightest 1% of the picture by appropriate numbers so that the whole spectrum is linearly stretched out.

In some embodiments, a histogram stretch function used to generate an image variation has the following form:

HistogramStretch(image, red percentage, green percentage, blue percentage),

In such embodiments, eight image variations may be generated using the following eight histogram stretch functions:

image variation 1=HistogramStretch(image,0.005,0.005, 0.005);

image variation 2=HistogramStretch(image, 0.01, 0.01, 0.01);

image variation 3=HistogramStretch(image, 0.03, 0.03, 0.03);

image variation 4=HistogramStretch(image, 0.05, 0.05, 0.05);

image variation 5=HistogramStretch(image, 0.07, 0.07, 0.07);

image variation 6=HistogramStretch(image, 0.005, 0.03, 0.03);

image variation 7=HistogramStretch(image, 0.03, 0.005, 0.03);

image variation 8=HistogramStretch(image, 0.03, 0.03, 0.005);

where the first image variation is generated automatically from the uploaded image by separating the uploaded image into red, green, and blue components, and linearly stretching the intensities of the each component so that the darkest 0.5% of the monochromatic picture is assigned to black, the brightest 0.5% of the each monochromatic picture is assigned to the brightest shade of the monochromatic color that can be displayed on the device, and all shades in the middle are linearly brightened up or dimmed down, and then the combined color image is returned. And so on.

In some embodiments, the method includes displaying the uploaded image and the image variations simultaneously on a display device. In some embodiments, the uploaded image and the image variations are all displayed on the display device at the same time. In some embodiments, the uploaded image and the image variations are displayed in a three by three matrix. In some embodiments, the three by three matrix has the same configuration as that of the three by three matrix shown in the schematic diagram 200. The uploaded image may be displayed at the center of the matrix. The image variations may be displayed in outer columns and/or outer rows of the matrix.

At 306, the method may further include selecting a desired image variation (i.e., a desired one of the image variations). In some embodiments, the desired image variation defines a currently preferred image. In some embodiments, it may be possible to select the uploaded image, rather than an image variation, as the currently preferred image. In such embodiments, the method may include selecting a currently preferred image from a group of images that includes the uploaded image and the image variations.

In some embodiments, all of the image variations are automatically generated and displayed before a selection is made.

At 308, the method may further include generating image variations using a discrete gamma method. In some embodiments, the image variations comprise variations of the currently preferred image.

Dark images (i.e., pictures or other types of images) can be a problem. In some embodiments, generating an image variation using a discrete gamma method brings out details of a dark part of an image (i.e., a picture or other type of image) and makes the overall image a bit brighter.

In some embodiments, generating image variations using a discrete gamma method includes automatically converting a first range of brightness associated with the currently preferred image to an expanded range of brightness and automatically converting a second range of brightness to a contracted range of brightness, wherein each of said plurality of variations converts a different first range of brightness associated with the currently preferred image to a different expanded range of brightness and converts a different second range of brightness associated with the currently preferred image to a different contracted range of brightness.

In some embodiments, generating image variations using a discrete gamma method includes generating the image variations from the currently preferred image using a discrete gamma function. In some embodiments, a discrete gamma function used to generate an image variation has the following form:

DiscreteGamma(image, original range, expanded range),

In such embodiments, eight image variations may be generated using the following eight discrete gamma functions:

image variation 1=DiscreteGamma(image, 64, 84);

image variation 2=DiscreteGamma(image, 64, 102);

image variation 3=DiscreteGamma(image, 64, 121);

image variation 4=DiscreteGamma(image, 64, 150);

image variation 5=DiscreteGamma(p, 128, 170);

image variation 6=DiscreteGamma(p, 128, 210);

image variation 7=DiscreteGamma(p, 128, 228);

image variation 8=DiscreteGamma(p, 128, 247);

where assuming that pixels values in the image range from 0 (black) to 255 (white), image variation 1 is generated automatically by expanding the range of from 0 to 64 into a new range of from 0 to 84, and expanding the range 65 to 255 into a new but smaller range of 84 to 255. And so on.

In some embodiments, the method includes displaying the currently preferred image and the image variations on a display device together at the same time. In some such embodiments (and/or some of any other embodiments disclosed herein), the currently preferred image and the image variations are all displayed on the display device at the same time. In some embodiments, the currently preferred image and the image variations are displayed in a three by three matrix. The three by three matrix may have the same configuration as that of the three by three matrix shown in the schematic diagram 200. The currently preferred image may be displayed at a center of the matrix. The image variations may be displayed in outer columns and/or outer rows of the matrix.

At 310, the method may further include selecting a desired image variation (i.e., a desired one of the image variations). In some embodiments, the desired variation defines a new currently preferred image. In some embodiments, it may be possible to select the currently preferred image, rather than an image variation, as the new currently preferred image. In such embodiments, the method may include selecting a new currently preferred image from a group of images that includes the currently preferred image and the image variations.

In some embodiments, all of the image variations are automatically generated and displayed before a selection is made.

At 312, the method may further include generating image variations using a gamma on intensity method. In some embodiments, the image variations comprise variations of the currently preferred image.

In some embodiments, generating image variations using a gamma on intensity method creates variations of the currently preferred image by altering the brightness without changing neither the saturation nor the hue of the currently preferred image. In some embodiments, it does so by taking the existing distribution of brightness, e.g., from 0 to 255, and applying the gamma function:

if brightness is below 128, new brightness=128×((brightness/128)̂GAMMA)

if brightness is above 128, new brightness=255−(128×(2−(brightness/128))̂GAMMA))

In some embodiments, generating image variations using a gamma on intensity method includes generating the image variations from the currently preferred image using a gamma on intensity function. In some embodiments, a gamma on intensity function used to generate an image variation has the following form:

GammaOnintensity(image, gamma value),

In such embodiments, eight image variations may be generated using the following eight gamma on intensity functions:

image variation 1=GammaOnintensity(image, 0.3);

image variation 2=GammaOnintensity(image, 0.4);

image variation 3=GammaOnintensity(image, 0.5);

image variation 4=GammaOnintensity(image, 0.6);

image variation 5=GammaOnintensity(image, 0.7);

image variation 6=GammaOnintensity(image, 0.8);

image variation 7=GammaOnintensity(image, 0.9);

image variation 8=GammaOnintensity(image, 1.1);

In some embodiments, the method includes displaying the currently preferred image and the image variations on a display device.

At 314, the method may further include selecting a desired image variation (i.e., a desired one of the image variations). In some embodiments, the desired variation defines a new currently preferred image. In some embodiments, it may be possible to select the currently preferred image, rather than an image variation, as the new currently preferred image. In such embodiments, the method may include selecting a new currently preferred image from a group of images that includes the currently preferred image and the image variations.

In some embodiments, all of the image variations are generated and displayed before a selection is made.

At 316, the method may further include generating image variations using a gamma on saturation method. In some embodiments, the image variations comprise variations of the currently preferred image.

In some embodiments, this step creates image variations by altering saturation. In some embodiments, it does so by taking the existing distribution of saturation, e.g., from 0 to 360, and applying the gamma function:

if saturation is below 180, new saturation=180×((saturation/180)̂GAMMA)

if saturation is above 180, new saturation=360−(180×(2−(saturation/180))̂GAMMA))

In some embodiments, generating image variations using a gamma on saturation method includes automatically manipulating a saturation associated with the currently preferred image, wherein each of said plurality of variations has a different variation of the saturation associated with the currently preferred image.

In some embodiments, generating image variations using a gamma on saturation method includes generating the image variations from the currently preferred image using a gamma on saturation function. In some embodiments, a gamma on saturation function used to generate an image variation has the following form:

GammaOnSaturation(image, gamma value),

In such embodiments, eight image variations may be generated using the following eight gamma on saturation functions:

image variation 1=GammaOnSaturation(image, 0.5);

image variation 2=GammaOnSaturation(image, 0.6);

image variation 3=GammaOnSaturation(image, 0.8);

image variation 4=GammaOnSaturation(image, 0.9);

image variation 5=GammaOnSaturation(image, 1.1);

image variation 6=GammaOnSaturation(image, 1.2);

image variation 7=GammaOnSaturation(image, 1.5);

image variation 8=GammaOnSaturation(image, 2.0);

In some embodiments, the method includes displaying the currently preferred image and the image variations on a display device.

At 318, the method may further include selecting a desired image variation (i.e., a desired one of the image variations). In some embodiments, the desired variation defines a new currently preferred image. In some embodiments, it may be possible to select the currently preferred image, rather than an image variation, as the new currently preferred image. In such embodiments, the method may include selecting a new currently preferred image from a group of images that includes the currently preferred image and the image variations.

In some embodiments, all of the image variations are generated and displayed before a selection is made.

At 320, the method may further include generating image variations using a sharpen method. In some embodiments, the image variations comprise variations of the currently preferred image.

In some embodiments, generating image variations using a sharpen method includes generating image variations that are of different degrees of sharpness. In some embodiments, each image variation is created by constructing a 3 by 3 matrix mask for sharpening.

In some embodiments, generating image variations using a sharpen method includes automatically manipulating sharpness associated with the currently preferred image, wherein each of said plurality of variations has a different variation of the sharpness associated with the currently preferred image.

In some embodiments, the method includes displaying the currently preferred image and the image variations on a display device.

At 322, the method may further include selecting by a user a desired image variation (i.e., a desired one of the image variations) from the automatically generated image variations. In some embodiments, the desired variation defines a new currently preferred image. In some embodiments, it may be possible to select the currently preferred image, rather than an image variation, as the new currently preferred image. In such embodiments, the method may include selecting by a user a new currently preferred image from a group of images that includes the currently preferred image and the automatically generated image variations.

In some embodiments, the image may be saved as a computer readable file. In some embodiments, the computer readable file may be sent out as an attachment in a mail to friends and relatives and/or uploaded for printing on a photographic paper by a suitable printing device or by a professional printer.

In some embodiments, said uploading is performed using at least one of a computer, a kiosk, a stand-alone digital photo-frame, a hand-held device with a display window, or any similar device suitable for displaying images. In some embodiments, the computer, kiosk, stand-alone digital photo-frame, hand-held device with a display window, or any similar device is networked.

In some embodiments, one or more portions of any method disclosed herein is performed by a user operating at least one of a computer, a kiosk, a stand-alone digital photo-frame, a hand-held device with a display window, or any similar device suitable for displaying images. In some embodiments, the computer, kiosk, stand-alone digital photo-frame, hand-held device with a display window, or any similar device is networked.

In some embodiments, the display device comprises a display of a user device, a digital camera, a mobile phone, a digital video camera, a electronic copier, a fax machine, a scanner, a flat screen television, any image projector, a stand-alone digital photo-frame, a networked digital photo-frame, a networked computer and/or a kiosk (networked or not networked).

In some embodiments, the selecting of an image is performed using at least one of a networked computer, a networked kiosk, a stand-alone digital photo-frame, a networked digital photo-frame, and a networked hand-held device with a display window. In some embodiments, the selecting of an image is performed by a user operating at least one of a networked computer, a networked kiosk, a stand-alone digital photo-frame, a networked digital photo-frame, and a networked hand-held device with a display window.

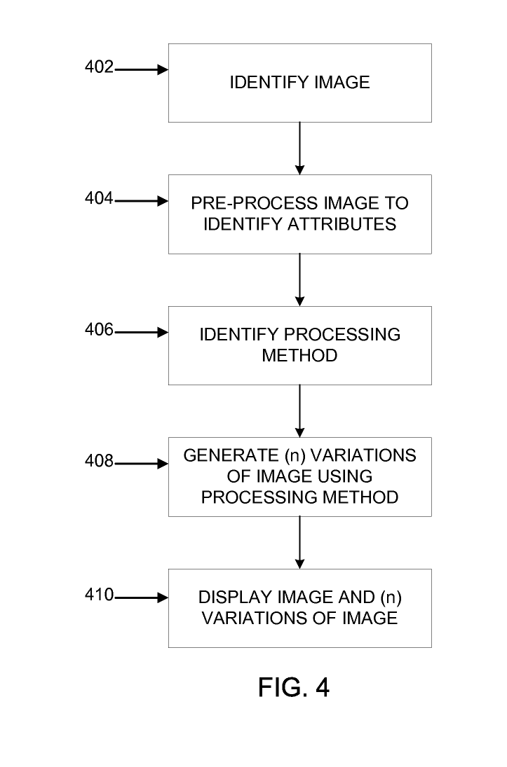

FIG. 4 is a flow chart of a method 400 according to some embodiments. In some embodiments, one or more portions of the method are used in improving an image. Referring to FIG. 4, at 402, the method may include identifying an image. In some embodiments, identifying an image comprises selecting an original image for improvement. In some embodiments, the identifying and/or selecting is performed using at least one of a networked computer and a networked kiosk. In some embodiments, the identifying and/or selecting is performed by a user operating at least one of a networked computer and a networked kiosk.

At 404, the method may further include pre-processing the image to identify attributes.

At 406, the method may further include identifying a processing method.

At 408, the method may further include generating n variations (e.g., one or more variations) of the image using the identified processing method.

At 410, the method may further include displaying the image and the n variations of the image on a display device. In some embodiments, the display device comprises a display of at least one of a networked computer and a networked kiosk. In some embodiments, the image and the n variations are all displayed on the display device at the same time. In some embodiments, the n variations comprise eight images. In some embodiments, the image and the n variations are displayed in a three by three matrix. In some embodiments, the image is displayed at a center of the matrix. In some embodiments, the n variations are displayed in outer columns and/or outer rows of the matrix.

In some embodiments, generating image variations using the identified processing method includes automatically manipulating one or more characteristics associated with the uploaded image, wherein each of said n variations has a different manipulation of the one or more characteristics associated with the uploaded image.

In some embodiments, the processing method comprises a histogram stretch processing method and each of said variations is generated by performing a histogram stretch of said image using variations of red, green, and blue values of said original image.

In some embodiments, the method may further include selecting an image from the displayed images. In some embodiments, the selected image comprises a currently preferred image.

In some embodiments, the method may further include generating n variations of the currently preferred image variation.

In some embodiments, the method may further include displaying the image and the n variations of the image on a display device. In some embodiments, the currently preferred image and the n variations are all displayed on the display device at the same time. In some embodiments, the n variations comprise eight images. In some embodiments, the currently preferred image and the n variations are displayed in a three by three matrix. In some embodiments, the currently preferred image is displayed at a center of the matrix. In some embodiments, the n variations are displayed in outer columns and/or outer rows of the matrix.

In some embodiments, the method may further include selecting an image from the displayed images. In some embodiments, the selected image defines a new currently preferred image.

In some embodiments, the generating of the n variations, the displaying of images, and the selecting of a new currently preferred image may be repeated until a final image is selected. In some embodiments, the method includes saving the final image (and/or any image generated by the method) in a computer-readable image format.

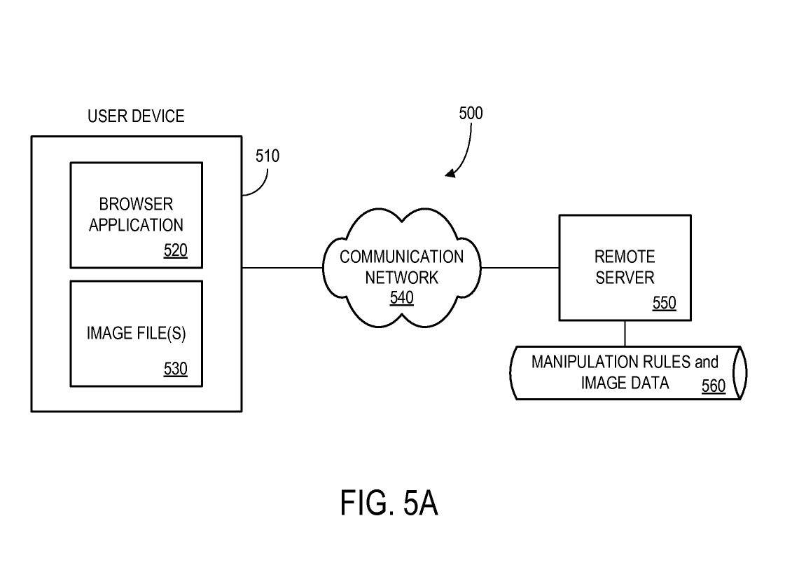

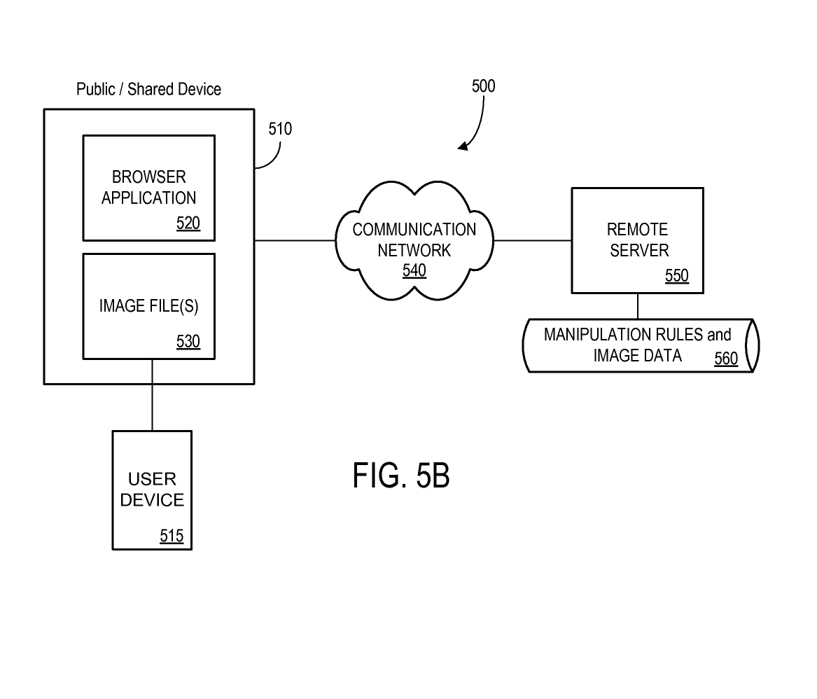

FIGS. 5A-5B are schematic diagrams of a system 500, in accordance with some embodiments. In some embodiments, one or more portions of the system are used in improving an image. In some embodiments, one or more portions of the system 500 may be used to perform one or more portions of one or more methods disclosed herein.

Referring to FIG. 5A, the system 500 includes a user device 510. The user device 510 may include a browser application 520 and one or more image files 530. The browser application 520 may allow the user device 510 to act as a client device. The one or more image files 530 may define one or more images.

The user device 510 may further include a display and a mouse, a pointer, a tracking ball, a remote control, a keyboard, a touch pad, and/or other input device (none of which is separately shown). A display may allow the user device 510 to display a graphical user interface and/or other information to a user. A mouse, a pointer, a tracking ball, a remote control, a keyboard, a touch pad, and/or other input device may allow the user device 510 to receive input from a user.

The system 500 may further include a communication network 540, a remote server 550 and a storage device 560. The communication network 540 may be coupled to the user device 510 and a remote server 550 and may define a portion of a communication link that couples the user device 510 and a remote server 550. The storage device 560 may store manipulation rules and/or image data. The manipulation rules may comprise rules for generating image variations. The manipulation rules and image data may each have any form(s) and may each be supplied by any source(s) and may have any form(s). In some embodiments, one or more portions of the manipulation rules are in the form of one or more instructions that are stored on the storage device 560 and/or to be executed by the user device 510 and/or a remote server 550 to perform one or more portions of one or more methods disclosed herein. In some embodiments, one or more portions of the image data are stored in one more databases stored on the storage device 560.

As stated above, one or more portions of the system 500 may be used to perform one or more portions of one or more methods disclosed herein. In that regard, in some embodiments, a user may use the user device 510 to upload and/or identify an image. If an image is uploaded, it may be stored in one of the image files 530. If an image is identified, the identified image may comprise an image defined by one of the image files 530.

In some embodiments, the user uploads and/or identifies the image after a prompt by the user device 510. The prompt may be provided via a graphical user interface. The graphical user interface may include one or more views downloaded, in whole or in part, from the a remote server 550 using the browser application 520.

The system 500 may also include one or more preference servers (not shown) which may be used to apply additional preferences during an image manipulation process. For example, a preference server may be used to apply local or regional preferences (such as a preferred language for transactions occurring in a given region or locality). As another example, a preference server may be used to apply sponsor preferences. For example, in embodiments where features of the present invention are provided as a service for customers of a drug store or other retail location, the preference server may be used to apply one or more preferences defined by the retailer, such as a preferred background image, advertising messages, etc. In this manner, a retailer or other sponsor can create and impose branding or other images in the image manipulation process. Further, the preferences can easily be changed by the sponsor by communicating updates to the preferences server.

Referring again to FIG. 5A, the user device 510 may transmit the image to the remote server 550, which may store the image as image data. The remote server 550 may generate a plurality of image variations in accordance with the manipulation rules. The image variations may be transmitted to the user device 510, which may display the image and the image variations using a graphical user interface.

The user may use the user device 510 to select a currently preferred image. In some embodiments, the user selects the currently preferred image after a prompt by the user device 510. The prompt may be provided via the graphical user interface. The graphical user interface may include one or more views downloaded, in whole or in part, from the remote server 550 using the browser application 520.

Referring now to FIG. 5B, a further embodiment is shown where a user carries or brings images to a public or shared device (such as a kiosk shown as item 510) using a portable device 515. For example, device 510 may be a public kiosk or other device (e.g., such as a kiosk at a drugstore or the like) that allows users to perform image manipulation pursuant to the present invention. In some embodiments, the device 510 may provide other services, such as photo printing or the like. Portable device 515 may be, for example, a portable USB device, a digital camera, a mobile phone, a SIM card, a video camera, a CDROM, or any other portable media. The processing of images is performed similar to the system shown in FIG. 5A.

In some embodiments, the generating of the image variations, the displaying of images, and the selecting of a new currently preferred image may be repeated until a final image is selected. In some embodiments, the final image (and/or any image generated by the system) may be saved in a computer-readable image format.

In some embodiments, the user device 510 comprises a conventional personal computer and/or a kiosk. In some embodiments, the user device 510 sends images to, and/or receives images from, the remote server 550, via the communication network 540. While only a single server 550 is shown, those skilled in the art will appreciate that server 550 may consist of a cluster or network of servers adapted to process images pursuant to embodiments disclosed herein. Further, in some embodiments, some of the processing described herein may be performed at the client device, or at the server.

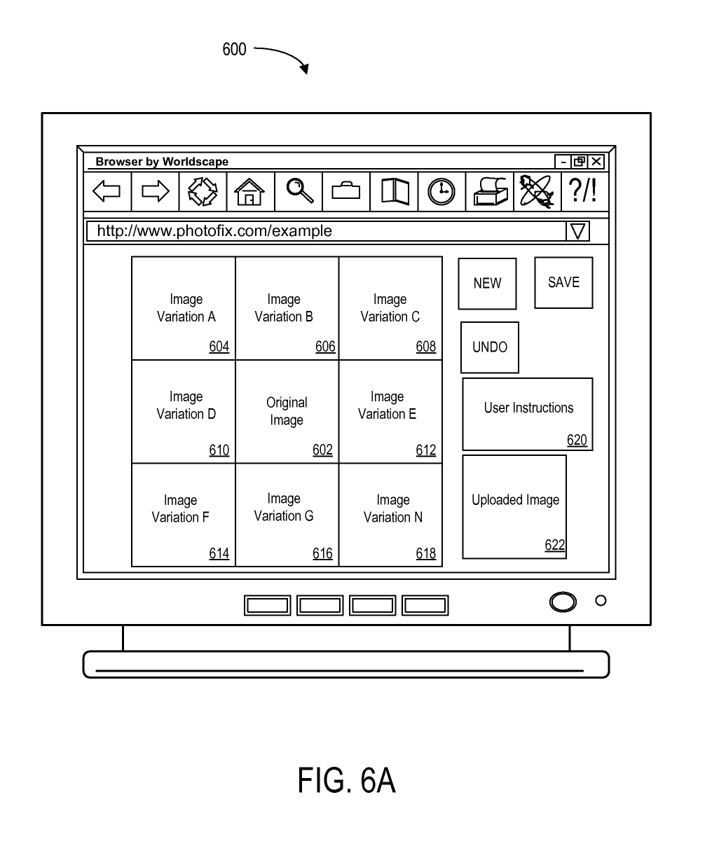

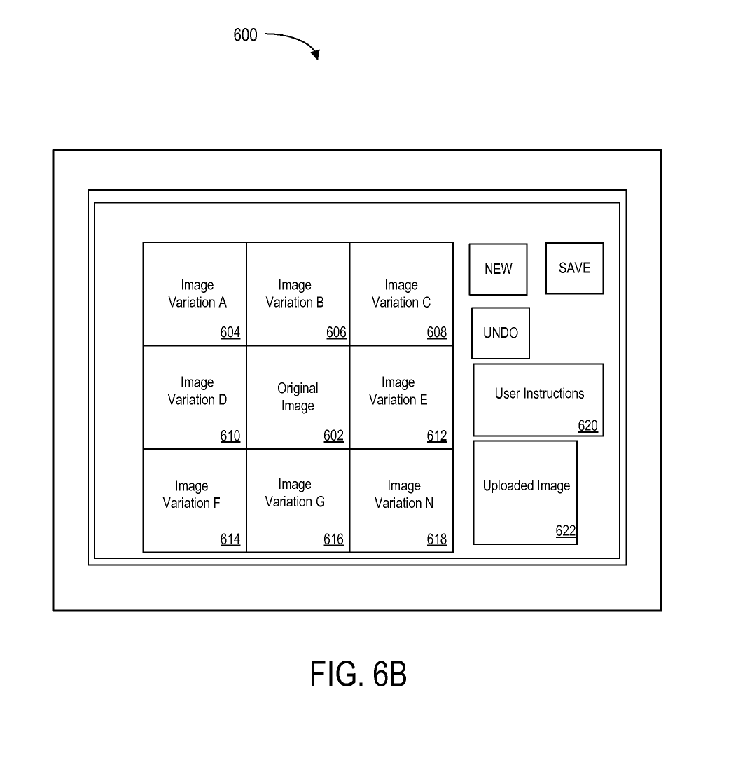

FIGS. 6A and B are schematic diagrams of various display devices 600 displaying a view of a graphical user interface, in accordance with some embodiments. In some embodiments, one or more portions of the graphical user interface are used in improving an image. Referring to FIG. 6A, in some embodiments, the display device 600 may include a housing, a stand, an on/off button and on/off indicator and one or more buttons for adjusting one or more characteristics of the display 600, such as for example as shown. However, other types of display devices may also be employed.

The view of the graphical user interface may include a plurality of images 602-618. In some embodiments, the plurality of images are (i) the same as and/or similar to the plurality of images 202-218, respectively, in the schematic diagram 200 and/or (ii) arranged in a manner that is the same as and/or similar to the plurality of images 202-218, respectively in the schematic diagram. In that regard, the plurality of images 602-618 may be displayed in a three by three (3×3) matrix. In some embodiments, the image 602 comprises an original image, a currently preferred image and/or an image for improvement. The other images 604-618 may comprise variations of the image 602. The image 602 may be displayed at a center of the matrix. The other images 604-618 may be displayed in outer columns and/or outer rows of the matrix.

In some embodiments, a user may select an image from (i) the images 604-618 and/or (ii) the images 602-618. In some embodiments, such selected image defines a new currently preferred image.

The view of the graphical user interface may further include user instructions 620 and/or an uploaded image 622. In some embodiments, the uploaded image 622 may define an original image, a currently preferred image and/or an image for improvement. The instructions 620 may comprise instructions for uploading and/or selecting an image from (i) the images 604-618 and/or (ii) the images 602-618.

Referring to FIG. 6B, a further display device 600 is shown which may be, for example, a digital photo-frame. In some embodiments, the digital photo-frame may be a standalone device. Images may be loaded onto the photo-frame using a network connection, a USB connection, a wireless network, a memory card, and by other similar means. Once images are loaded, they may be manipulated using touch screen interaction or using navigation buttons (not shown) on the frame. Those skilled in the art will appreciate that a wide variety of different display devices may be used and those shown herein are illustrative, but not exhaustive.

In some embodiments, in a client-server type of deployment, a remote device or processing server may detect the quality and/or the resolution of the display device on the client side and may automatically (or manually under the control of the user) select the size of the matrix as well as the size of the individual window for each of the images 602-618.

In some embodiments, the view may further include a toolbar, a universal resource locator (URL) and other graphical tools (e.g., for saving an image, undoing an action and starting a new session). In some embodiments, the URL may define an address of the remote server 550 (FIG. 5) in the system 500 (FIG. 5).

Other graphical user interfaces may also be employed.

As used herein, “database” may refer to one or more related or unrelated databases. Data may be “stored” in raw, excerpted, summarized and/or analyzed form.

Unless otherwise stated, terms such as, for example, “in response to” and “based on” mean “in response at least to” and “based at least on”, respectively, so as not to preclude being responsive to and/or based on, more than one thing.

In addition, unless stated otherwise, terms such as, for example, “comprises”, “has”, “includes”, and all forms thereof, are considered open-ended, so as not to preclude additional elements and/or features. In addition, unless stated otherwise, terms such as, for example, “a”, “one”, “first”, are considered open-ended, and do not mean “only a”, “only one” and “only a first”, respectively. Moreover, unless stated otherwise, the term “first” does not, by itself, require that there also be a “second”.

A number of variations and embodiments have been described. For example, in one aspect, a method includes: uploading an original image for improvement; generating a plurality of variations of said original image automatically, and without any input from the user; displaying said original image and said plurality of variations on a display device; and allowing the user to select a currently preferred image from said displayed images.

In some embodiments, the method further includes generating a plurality of variations of said currently preferred image automatically, and without any input from the user; displaying said currently preferred image and said plurality of variations of said currently preferred image on a display device; allowing the user to make further select a new currently preferred image from said displayed images; repeating said automatic generating a plurality of variations, said displaying said preferred image and said selecting a new currently preferred image until a final image is selected.

In some embodiments, generating a plurality of variations of said original image comprises generating eight variations, and displaying said original image and said plurality of variations of said original image on a display device in a three by three matrix.

In some embodiments, generating a plurality of variations of said original image comprises generating eight variations, and displaying said original image and said plurality of variations of said original image on a display device one at a time sequentially.

In some embodiments, generating a plurality of variations of said original image comprises generating one variation, and displaying said original image and said variation of said original image on a display device next to each other.

In some embodiments, generating a plurality of variations of said original image comprises generating an appropriate number of variations, given the size and the resolution of a display device, and displaying said original image and said plurality of variations of said original image on the display device in a matrix. In this case, the program may choose to display a higher number of variations if the display device has a higher resolution, or if the display is larger.

In some embodiments, the original image may be displayed in an area designated as “the Original Image”.

In some embodiments, generating a plurality of variations of said original image comprises: automatically manipulating image contrast data associated with said original image, wherein each of said plurality of variations has a different image contrast setting based on said original image.

In some embodiments, generating a plurality of variations of said original image comprises: automatically manipulating at least one of, but not limited to (a) brightness (or intensity) data associated with the original image, (b) hue data associated with the original image, (c) saturation data associated with the original image, (d) the red, green, and/or blue data associated with the original image, and (e) sharpening or smoothing of the original image, (f) cropping of the original image, (g) rotating the original image, (f)flipping the original image, (g)skewing the original image, (h)increasing or decreasing the original image size.

In some embodiments, selecting an original image for improvement further comprises: uploading by a user, an image file to a processing server, which may be remotely located from the user; and selecting said image in said image file as said original image.

In some embodiments, said uploading is performed using at least one of a computer, a kiosk, a stand-alone digital photo-frame, a hand-held device with a display window, or any similar device suitable for displaying images. In some embodiments, the computer, kiosk, stand-alone digital photo-frame, hand-held device with a display window, or any similar device is networked. In addition, in some embodiments, said uploading is performed automatically by a copier or scanner, so that, instead of user selecting brightness or contrast control of a image copier or scanner prior to copying or scanning the image, a copied or scanned image and the plurality of automatically generated variations of the said scanned or copied image are displayed in accordance with the said method for the user to choose at once the right setting. In some embodiments, said selecting steps are performed by a user operating a networked computer.

In another aspect, a method for selecting a preferred version of an image includes: uploading an original image for improvement; automatically and without any input from the user, generating a plurality of variations of said original image, each of said variations generated by applying a specific image processing function to the said original image repeatedly, each time with a different setting a varying degree any one of said original image and using variations of red, green, and blue values of said original image; displaying said original image and said plurality of variations on a display device; selecting a currently preferred image from said displayed images; generating a plurality of variations of said currently preferred image; displaying said currently preferred image and said plurality of variations of said currently preferred image on a display device; selecting a new currently preferred image from said displayed images; repeating said generating a plurality of variations, said displaying said preferred image and said selecting a new currently preferred image until a final image is selected.

In another aspect, a method for returning to the original image is provided.

In another aspect, a method for returning to the previous currently preferred image is provided (“Undo feature”).

In another aspect, a computer-readable medium storing instructions adapted to be executed by a processor to perform a method of processing an image, said method comprising: selecting an original image for improvement; generating a plurality of variations of said original image automatically; displaying said original image and said plurality of variations on a display device; and selecting a currently preferred image from said displayed images.

In some embodiments, the method of processing an image further includes generating a plurality of variations of said currently preferred image; displaying said currently preferred image and said plurality of variations of said currently preferred image on a display device; selecting a new currently preferred image from said displayed images; and repeating said generating a plurality of variations, said displaying said preferred image and said selecting a new currently preferred image until a final image is selected.

In another aspect, an image processing system includes: a communication device to receive and transmit information, said information including image data and selection data received from a user device; a processor coupled to the communication device; and a storage device in communication with said processor and storing instructions adapted to be executed by said processor to: select an original image for improvement; generate a plurality of variations of said original image; display said original image and said plurality of variations on a display device associated with said user device; and select a currently preferred image from said displayed images.

In some embodiments, the image processing system includes instructions adapted to be executed by said processor to: generate a plurality of variations of said currently preferred image; display said currently preferred image and said plurality of variations of said currently preferred image on a display device associated with said user device; select a new currently preferred image from said displayed images; and repeat said generating a plurality of variations, said displaying said preferred image and said selecting a new currently preferred image until a final image is selected.

Some embodiments may be used in improving an image.

Some embodiments may be used by a user without any need to study a manual nor to learn how to invoke any of the offered options.

Some embodiments may provide greater improvement than is typically achieved using automatic functions provided by other programs.

Some embodiments may provide more efficient way to invoke a large number of options much faster and more efficiently than other programs.

While various embodiments have been described, such description should not be interpreted in a limiting sense. It is to be understood that modifications of such embodiments, as well as additional embodiments, may be utilized without departing from the spirit and scope of the invention, as recited in the claims appended hereto.

What is claimed is:

1. A method for improving an image, comprising:
selecting an original image for improvement;
generating a plurality of variations of said original image;
displaying said original image and said plurality of variations on a display device; and
selecting a currently preferred image from said displayed images.

2. The method of claim 1, further comprising:
generating a plurality of variations of said currently preferred image;
displaying said currently preferred image and said plurality of variations of said currently preferred image on a display device;
selecting a new currently preferred image from said displayed images;
repeating said generating a plurality of variations, said displaying said preferred image and said selecting a new currently preferred image until a final image is selected.

3. The method of claim 1, wherein said generating a plurality of variations of said original image comprises generating eight variations.

4. The method of claim 1, wherein said generating a plurality of variations of said original image comprises:
automatically manipulating image contrast data associated with said original image, wherein each of said plurality of variations has a different image contrast setting based on said original image.

5. The method of claim 2, wherein said generating a plurality of variations of said currently preferred image comprises:
automatically manipulating at least one of (i) brightness data associated with said currently preferred image, (ii) image intensity data associated with said currently preferred image, (iii) mood data associated with said currently preferred image, (iv) saturation data associated with said currently preferred image, and (iv) image sharpening data associated with said currently preferred image.

6. The method of claim 1, wherein said selecting an original image for improvement further comprises:
uploading, by a user, an image file to a processing server; and
selecting said image in said image file as said original image.

7. The method of claim 6, wherein said uploading is performed using at least one of a networked computer and a networked kiosk.

8. The method of claim 1, wherein said selecting steps are performed by a user operating a networked computer.

9. The method of claim 1, wherein said plurality of variations equals eight, and said displaying includes displaying said plurality of variations and said original image in a three by three matrix.

10. A method for selecting a preferred version of an image, comprising:
selecting an original image for improvement;
generating a plurality of variations of said original image, each of said variations generated by performing a histogram stretch of said original image and using variations of red, green, and blue values of said original image;
displaying said original image and said plurality of variations on a display device;
selecting a currently preferred image from said displayed images;
generating a plurality of variations of said currently preferred image;
displaying said currently preferred image and said plurality of variations of said currently preferred image on a display device;
selecting a new currently preferred image from said displayed images;
repeating said generating a plurality of variations, said displaying said preferred image and said selecting a new currently preferred image until a final image is selected.

11. A computer-readable medium storing instructions adapted to be executed by a processor to perform a method of processing an image, said method comprising:
selecting an original image for improvement;
generating a plurality of variations of said original image;
displaying said original image and said plurality of variations on a display device; and
selecting a currently preferred image from said displayed images.

12. The computer-readable medium storing instructions adapted to be executed by a processor to perform a method of processing an image of claim 11, said method further comprising:
generating a plurality of variations of said currently preferred image;
displaying said currently preferred image and said plurality of variations of said currently preferred image on a display device;
selecting a new currently preferred image from said displayed images; and
repeating said generating a plurality of variations, said displaying said preferred image and said selecting a new currently preferred image until a final image is selected.

13. An image processing system, comprising:
a communication device to receive and transmit information, said information including image data and selection data received from a user device;
a processor coupled to the communication device; and
a storage device in communication with said processor and storing instructions adapted to be executed by said processor to:
select an original image for improvement;
generate a plurality of variations of said original image;
display said original image and said plurality of variations on a display device associated with said user device; and
select a currently preferred image from said displayed images.

14. The image processing system of claim 13, further comprising instructions adapted to be executed by said processor to:
generate a plurality of variations of said currently preferred image;
display said currently preferred image and said plurality of variations of said currently preferred image on a display device associated with said user device;
select a new currently preferred image from said displayed images; and
repeat said generating a plurality of variations, said displaying said preferred image and said selecting a new currently preferred image until a final image is selected.

15. The image processing system of claim 13, wherein said instructions adapted to generate a plurality of variations of said original image comprises generating a number of variations based at least in part on characteristics of said display device associated with said user device.

16. The image processing system of claim 13, wherein said instructions adapted to generate a plurality of variations of said original image comprises:
automatically manipulating image contrast data associated with said original image, wherein each of said plurality of variations has a different image contrast setting based on said original image.

17. The image processing system of claim 13, wherein said instructions adapted to generate a plurality of variations of said currently preferred image comprises:
automatically manipulating at least one of (i) brightness data associated with said currently preferred image, (ii) image intensity data associated with said currently preferred image, (iii) mood data associated with said currently preferred image, (iv) saturation data associated with said currently preferred image, and (iv) image sharpening data associated with said currently preferred image.

18. The image processing system of claim 13, wherein said instructions adapted to select an original image for improvement further comprises instructions adapted to:
upload, by a user, an image file to a processing server; and
select said image in said image file as said original image.
